(19) United States
(12) Patent Application Publication
(10) Pub. No.: US 2022/0366408 A1
(43) Pub. Date: Nov. 17, 2022

(54) Digital Key With Monetary Value

(71) Applicant: BLE Looking OÜ, Tallinn (EE)

(72) Inventor: Priit Vimberg, Tallinn (EE)

(21) Appl. No.: 17/243,604

(22) Filed: Apr. 29, 2021

(51) Int. Cl. G06Q 20/38; G06Q 20/40; G07C 9/00; G06Q 20/12; G07C 9/38; G06Q 20/32; G06Q 10/00; H04L 29/06; H04L 9/08; G06F 16/245

(52) U.S. Cl. CPC G06Q 20/3829; G06Q 20/401; G07C 9/00571; G06Q 20/123; G07C 9/38; G06Q 20/3226; G06Q 10/20; H04L 63/10; H04L 9/0877; H04L 63/0428; H04L 9/0827; G06F 16/245; G06Q 50/06

(57) ABSTRACT

The disclosure is directed to use of digital keys in providing access to secured locations, goods and resources as well as other assets. The access may be fee based with the disclosure further directed to including fee payment authorization into the access process. Electronic locks may be employed within modules to faciltiate the access. The digital keys may be accompanied with commands for the electronic locks and/or modules accomodating them to execute in the course of providing the access. The digital keys may be shared, limited to single or multiple use and may be lock agnostic. The commands may be sent from a smart mobile device and be digitally signed for subsequent attestation by the lock for authenticity verification. The digital keys may be generated and otherwise handled under one of a series of escalating security encryption methods typically used and reserved for financial transactions.

### BACKGROUND OF THE INVENTION

The present disclosure generally relates to a controlled grant of access to any physical or virtual location as well as dispensing modules for goods and/or services. The grant of access may be enabled and/or facilitated electronically, via, for example, the communication and authentication of a digital key, with its authentication triggering access and its lack of authentication triggering a denial of access. More particularly, the present disclosure relates to a system and method for generating and distributing digital keys having different security levels, the keys being configured to selectively control appropriately configured electronic and software modules in a highly secure manner, the modules providing and/or otherwise facilitating access not only to a particular location but also to the goods and/or services, the latter for example optionally being against an authorized fee payment. Such may find application for example in the so-called Sharing Economy, wherein particular resources are shared by its using public, the sharing taking place over a finite amount of time and often times in exchange for value. Such particular resources may include access to: moving vehicles; accommodations; locations; business to business, business to customer and customer to customer resources and/or services; virtual resources, including software and hardware based resources; and the like as would be envisioned by the skilled person. Essentially to the success of any Sharing Economy undertaking is the importance of trust in the underlying bargained for exchange that enables the user with controlled and reliable access while enabling the provider with controlled and reliable compensation and the like. As applied within the context of the present disclosure, such trust may arise from the instant digital key(s) and their interaction with modules enabling the aforementioned access.

With respect to location access as such, the instant modules may refer to electronic locks configured to selectively grant physical access to a particular location when authentically activated. Such locations may include but are not limited to storage lockers, residences, businesses, buildings, motor vehicles, elevators, and the like. The instant modules may further be used to control and/or enable virtual access to particular software, software updates, virtual domains, cloud based services and/or resources, and the like. Further still, the instant modules may be used to control access to goods and/or services, such as a monetary based service for dispensing a commodity, including power for charging electric vehicles and the like. The intant modules may further be arranged and configured for online and offline functionality as may be suitable for particular environments and applications.

The present day electronic lock replaces manual force for effecting the releasing mechanical movements common to traditional non-electronic locks, with the controlled release and/or application of electric current. Generally speaking, operating an electric lock entails two steps: first, authenticating an electronic key; and second, if authentic, decoupling an entry barrier thereby facilitating a particular access. Whereas traditional mechanical locks employ traditional mechanical keys machined to fit their respective and particular locks, electronic locks employ particularly created electronic or digital keys. In operation, both types of locks entail a determination of whether their respective key is correct or authentic for engaging the respective lock such that the lock then responds to a user command, namely, locking or unlocking access. With mechanical locks, a mechanical key is received therein such that teeth of the mechanical key manually and suitably displaces lock tumblers thereby unobstructing movement of other elements of the lock facilitating the unlocking. As such, for mechanical keys, the key authentication process is mechanical under which an inappropriate key would either not fit and/or not suitably displace the lock tumblers thus preventing execution of the user's command. Electronic locks, on the other hand, rely upon electronic means to authenticate their respective keys. For example, the identity of the key may be confirmed from a list of authentic digital keys, the list being searchable by and/or for the electronic lock by local and/or remote software and processing means as is known in the art. If the digital key is determined as being authentic, the respective command associated with the current use of the key is then excuted by the lock.

Digital keys offer certain advantages over mechanical keys, including easier and less expensive creation, distribution and management. Additionally, given the electronic keys flexibility with respect to its physical manifestation, be it on a smart mobile device, card, USB, etc., the number of electronic keys thus available to a user is far greater than what would be realistically available and/or manageable with physical, mechanical keys. For example, digital keys may be created by appropriately configured computer systems, distributed via standard messaging protocols and managed with appropriately configured database software. Mechanical keys by contrast require physical manufacture and manual distribution, all constrained by some form of manual and/or automated physical labor, resource availability, and geographical or other such physical limitations. An additional advantage for digital keys over their mechanical counterparts is the electronic nature of the authentication process which lends itself to the inclusion and implementation of modern encryption techniques which are seemingly impossible to crack, whereas mechanical locks may be picked by those skilled in such art armed with readily available mechanical tools. Still other advantages to digital keys include use limitations unheard of for mechanical keys, such as time limits, user restrictions, and the like. Still further, electronic locks have also benefited from the widespread uptake of smart mobile devices, smart modules along with advancements in wireless communication and the computer arts generally, thus making them more attractive, flexible, cost effective and available than from before. Accordingly, electronic locks may be incorporated into modules providing a user with access to a variety of resources, including not only physical access to secured locations such as lockers, homes, offices, buildings, installations, physical locations and the like, but also virtual resources including access to software, updates, virtual or electronic domains and the like, and also to electronically controlled provision of resources where manual controls are difficult and/or dangerous, such as access to the flow of electricity for charging an electric vehicle. Unsurprisingly, electronic locks have gained in popularity with the variety of applications spreading from governments to businesses to the private sector.

With the above noted increase in popularity and use, comes the need for ever increasing security measures in order to protect the integrity and workings of not only the electronic lock and module but also the data being communicated via the digital keys. The need extends to applications operating in a variety of environments, in particular online and offline as may be operating in a host of diverse geographical environments and different applications. Likewise, there is a need within the Sharing Economy for the introduction of trust to the respective participants that their respective roles, contributions and assets will be respected and subject to accountability and control. With respect to virtual assets, such becomes especially problematic as access controls become limited to the digital key and its authentication by means not necessarily in the control of the user and/or the provider. Further still, there is a need in the art to simplify, at least from a user's perspective, the use of digital keys, so as to encourage their update and application.

### BRIEF SUMMARY OF THE INVENTION

The present disclosure is directed to improving the security, availability and operation of modules and data associated therewith, such modules including electronic locks, virtual locks and other forms of controlled access, through at least a system and method for selectively secured digital key creation and application and/or implementation thereof. Whereas known solutions entail use of a single digital key of modest singular security and distribution parameters, a feature of certain embodiments of the present dislcosure includes application of heretofore unapplied different security levels to numerous digital keys for enabling access to a wide range of physical and digital solutions, including electronic locks, through the application of numerous encryption and encryption related methods during the preparation for and execution of locking and unlocking commands along with subsequent communications and processing of sensitive user data as may be required for facilitating access and/or provision of goods and/or services.

Certain embodiments of the present disclosure include the generation of digital keys at selected levels of security heretofore found in financial and banking applications; including, for example, the generation of digital keys using Payment Card Industry Data Security Standard (PCI DSS) certified key generators. Such digital keys may be used in establishing and otherwise communicating with proprietary electronic locks, themselves configured to communicate with proprietary software distributed to a user in advance of operating the electronic lock. The electronic locks may further enjoy electronic, processing and communication support from a module housing or otherwise associated with the electronic lock. The software may be installed and run on a smart mobile device (such as the ubiquous smart phone), remote control and the like which include sufficient processing and communication features to enable wireless communication and data processing with and/or via proprietary locks and other remote systems. The communication is enabled by the running of the software in order to establish a channel of communication with the lock. The software further enables user registration, user association with the lock, appropriate key generation with possible limitations of key usage for specific times and number of key usages, and effective encrypted communication with the lock via the encrypted channel where also channel encryption keys are generated, distributed and managed by the system, making the modules visible only to the users who are holding the digital keys for the module. Still further, some or all of the electronic communications discussed herein may be encrypted to ensure reliability and security thereof.

Certain embodiments of the present disclosure are further directed to a backend or capable frontend in standalone offline situations, configured to generate the digital keys in cooperation with a frontend and modules which may include the user's smart mobile device and the electronic lock. Other electronic devices and systems capable of communicating with at least the backend may be envisioned within the scope of the present disclosure, including third party computers executing enterprise solutions, payment authorization systems and the like. In particular with respect to payment authorization systems, certain embodiments of the present invention include a trigger within the digital key to trigger payment authorization automatically with the use of the digital key, thereby obviating the well known separate integration of payment authentication, such as requiring additional user input including user name, password and the like, along with the authentication of the same.

User communication may be facilitated by the user's smart mobile device running the aforementioned software. Other communication vessels for digital keys may be considered here as would be envisioned by the skilled person. Through such communication, the user may register, request or generate a personal and unique digital key(s), execute commands on the electronic lock, the module housing it, and so forth. The requested digital keys may be generated by a variety of security and encryption methods. Digital keys may be asymmetric and include public and private keys with the backend further including a proprietary Certification Authority for attesting to the validity of the public keys when queried by, for example, online electronic locks, modules generally, smart mobile devices, third party financial institutions, and the like. Offline locks may include local functionality to authentic asymmetric keys, process payments, execute commands, and the like. Likewise, the digital keys may be symmetric, with the authentication of same being made similarly to the aforementioned. More advanced keys may use quantum encryption technologies. In application, the digital keys may be used by the smart mobile device, running the aforementioned software, to digitally sign and transmit commands and other needed instruction and/or information, from the user to the lock/module which, after the keys are authenticated, may be applied, processed, executed and the like by the module.

By way of certain embodiments of the present disclosure, the digital keys generated may be unique for each user as well as for each smart mobile device. Accordingly and dependent of the security level of the key, the same key cannot be transferred or otherwise reproduced for effective use on other smart mobile devices. The backend may further include key generation parameters and management. The parameters may include a select one from a plurality of increasingly secure encryption methods generally applied and otherwise reserved for the financial industry and financial transactions therein. Key management includes logging user requests and key generation along with key revocation, blacklisting and the like. Changes in key status may be communicated to the modules through various means, including direct online communication for online modules, optionally via encrypted channels similar to the aforementioned and/or piece meal piggybacking such communication over one or more smart mobile devices. Additional limitations may be placed on key use, including number and type of uses, time and geographical limitations and the like. Key generation may be made on smart mobile devices or over a safe public cloud infrastructure while at least some elements of the the aforementioned backend, optionally resident on a Virtual Private Data Center (VPDC), have controlled access thereto.

The number of keys generatable by certain embodiments of the present disclosure is limited only by the smart mobile device memory and processing configurations as well as storage capabilities. Accordingly, in some embodiments, the number of keys may run into the hundreds or thousands. Finding the right key from the possible hundreds or thousands of keys in a users' posession may be made easier via location based functionality, wherein particular keys may be associated with particular locations within the processing means of the smart mobile device. Locations may be based upon GPS coordinates, cell tower triangulation or broadcast methods on lower range wireless connections and the like as may be envisioned by the skilled person. Additionally, locations may be based upon a service or commodity provided for or otherwise dispensed by the module accommodating the electronic lock. Activation of such automatic key association functionality may be made by bringing the smart mobile device into communication range with a particular module, shaking the smart mobile device, and any other activation methods as may be envisioned by the skilled person. As the electronic locks and software running on the smart mobile device are proprietary, such may be preconfigured to cooperate accordingly. Helper methods, including automatic activation of sending the key to the electronic lock, may have a special purpose for users with disabilities who can initiate automatic opening and/or select access based upon different helper functions. Key requests and usages may be stored in a data warehouse which may be encrypted so as to be accessible only by key generators and policy servers. Keys can be generated anonymously for user privacy protection purposes. Key generators may have key-on-demand functionality to initiate key generation by specified authorities or other entities. Those functions enable scenarios where keys will not be in users device all the time for privacy or security reasons and keys will be generated and/or distributed just before the need of access. This is specifically needed by risk organizations and care givers or highly secured establishments to minimize the damages on entrance to premises where users need emergency help. Systems may have log engines to track the usage of every action, generation, event and the like that happens in system backend, frontend or in modules. Log analyzers may further include read-only access to data, with the data anonymized and coded via indexes of locks and users. Still further applications may be found with dispensing of goods, services and commodities involving authentication not only of the user but the user's ability to pay for the same.

The frontend may further include proprietary smart modules, online or offline, being in a closed system with the backend. The modules may be preprogrammed to recognize particular queries generated by smart mobile devices running the aforementioned proprietary software and set up an encrypted communication channel therewith. The modules may further include their own digital keys to enable the encrypted communication and the modules may generate the keys for its communication and key exchange with any smart mobile device.

Certain embodiments of the present disclosure are further directed to methods for creating and using digital keys when communicating commands to modules. The methods may include preconfiguring modules to appropriately and/or via encryption communicate with the smart mobile devices running proprietary software; the modules themselves, as per the aforementioned, being directed to the provision of goods, services, commodities and the like, against, optionally, verified and authenticated fee payment, user idenficiation and other sensitive data, the safe communication of which is enabled by the instant digital keys employed according to the certain embodiments.

Digital keys may be generated locally at the smart mobile device in cooperation with the backend and module as well as in the backend, upon request from the software. The steps for the same may include enabling communication between module and smart mobile device; communicating from the module to the smart mobile device a digital key for authenticating at the module offline or online; communicating to the smart mobile device a confirmation of authentication which in turn prompts the smart mobile device to communicate commands which upon receipt at the module are executed and confirmed.

The communication between the smart mobile device and module may be an encrypted communication channel set up with asymmetric keys. For example, such methods may include enabling communication between module and smart mobile device; exchanging a public key either from module to smart mobile device or visa versa; attesting the public key; and encrypting subsequent communications with the attested public key, the subsequent communications including module commands and confirmations of their receipt and execution.

A further feature of certain embodiments of the present disclosure include the communication of maintenance information with the modules. Where the modules are online, such communication may be enabled accordingly. Where such modules are offline, such communication may be taken up by a user's smart mobile device and/or other smart mobile devices registered, authorized and/or otherwise associated with the module so as to deliver updated maintenance information thereto. Maintenance information may include updated digital key status, attestations, timing, clock and other such data.

Further advantages, features and details of the present disclosure result from the following description of preferred embodiments and drawings. The characteristics and combinations of features mentioned above in the description, as well as the characteristics and combinations of features listed below in the description of figures and/or shown in the figures alone, are not limited to the combination indicated in each case; but can also be used in other combinations or on their own without leaving the scope of the invention.

### BRIEF DESCRIPTION OF THE SEVERAL VIEWS OF THE DRAWINGS

The accompanying drawings, which are incorporated in and constitute a part of this disclosure, illustrate exemplary embodiments and, together with the description, serve to explain the disclosed principles, wherein:

FIG. 1 depicts a high-level overview of system architecture employable with certain embodiments of the present description;

FIG. 2 depicts digital certificates generation, communication and use in confirmation;

FIG. 3 depicts digital key generation architecture;

FIG. 4 depicts provision of maintenance information to an offline module;

FIG. 5A depicts application of certain embodiments to online modules;

FIG. 5B depicts application of certain embodiments to offline modules;

FIG. 6 a process flow overview for obtaining a digital key and making use of same;

FIG. 7 depicts a method according to certain embodiments of present embodiments;

FIG. 8 depicts another method according to certain embodiments of present embodiments; and

FIG. 9 depicts still another method according to certain embodiments of present embodiments.

### DETAILED DESCRIPTION OF THE INVENTION

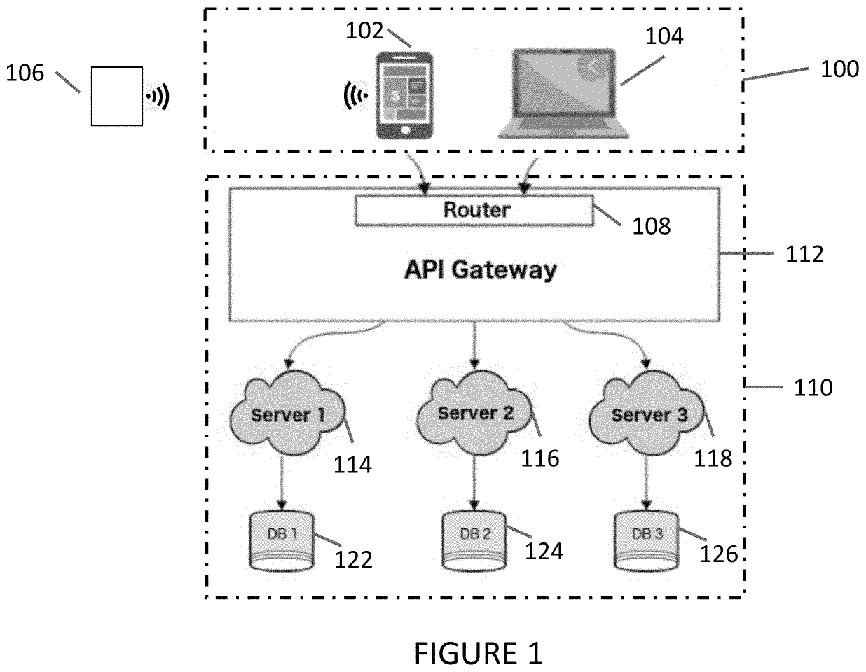

A high level overview of system architecture which may be employed by embodiments of the present disclosure is depicted in FIG. 1. As shown, a frontend 100 is depicted including, by way of example, an enterprise user 104 and a smart mobile device 102 in communication with a module 106. Frontend 100 is arranged and configured to be in communication with a backend 110. The frontend may include any number of smart mobile devices with the depicted device being a smart phone by way of example only. As shown, smart mobile device 102 and enterprise user 104 are arranged in communication with a router 108 and API gateway 112 located in the backend 110 and configured to selectively direct incoming traffic to at least a select one of three servers 114, 116, 118 running applications thereon and in communication with an own database 122, 124, 126 respectively.

Any number of communications within or between the frontend and backend respectively may be encrypted. Routers are well known in the computer arts as a networking device configured to forward packet data between computer networks, while API gateways are known servers which may act as API front-ends for receiving API requests, enforcing throttling and security policies, and passing requests to backend services as well as responses back out to respective requesters. The aforementioned communications may comprise API requests. Accordingly, a user in the frontend is in communication with applications running in the backend. Such applications may include those devoted to digital key generation; user, permission and device management; online device monitoring, procurement and firmware updates; and 3^{rd} party solutions including financial payments processing which may be engaged via application of particular content of the digital key itself.

In order to ensure secure communications between user and module, cryptographic systems may be employed in key generation and creation of an encrypted communication channel between user and module. Once secure communication is established between the smart mobile device 102 and module 106, commands, updates and sensitive user data may be communicated between the two to, for example, affect an action at the module.

The module may comprise an electronic lock or its equivalent depending upon application configured and arranged to facilitate select access to particular physical or virtual locations as well as goods and/or services. Examples of modules applying electronic locks for physical locations may include storage lockers, dwellings, buildings, motor vehicles, elevators and the like. The module may further comprise a service or commodity provider reactive to commands with payment authentications. Examples of same include provision of electrical power for charging electric vehicles and the like. Still other forms of payment authentication, in particular via backend 110, may be implemented.

Digital key generation is a well-known process in computer cryptography which essentially uses integers as keys. The keys may be randomly generated using for example known random number generators or pseudorandom number generators—a computer algorithm that, when executed, produces data that appears to be random when under analysis. Sizes of keys may also vary with, for example, larger keys being employed when greater security against discovery is desired.

By way of embodiments of the present disclosure, the keys are generated according to pre-selected security levels which may correspond to those typically associated within the financial services industry, such as with financial transactions. For example, the key generation may be secured and performed by a dedicated private hardware solution in a backend with such generation being selectively made in accordance with the Payment Card Data Industry Security Standards (PCI DSS) as well as by certified Hardware Security Module (HSM). For example, a high security level may conform to at least nShield FIPS 140 Level 3 HSM key generation while a standard security level may conform to up to nShield FIPS 140 Level 2 HSM key generation. Application of other security levels are envisioned. Various asynchronous and synchronous cypto algorithms as well as certain hash algorithms may be supported while the lengths and encryption algorythms of the keys may vary depending upon the select security level employed.

Cryptographic systems, employable by embodiments of the present invention, may include symmetric as well as asymmetric key algorithms. Initial keys may be generated locally in the frontend and module or remotely in the backend. In particular, the keys may be generated at the front end by a smart mobile device or module, as well as in the backend by an appropriately configured server, as may be dependent upon the policy implementations for certain key security levels. In addition, the key exchange may be affected in higher levels of security where an initial key is sent to a smart mobile device and after initial use the module will generate a new key along with other such confidences between the smart mobile device and module. Accordingly, from this moment onwards, only the module and smart mobile device have knowledge of the keys and confidences or secrets for the next lock opening. The key generation at the module is enabled by proprietary software configured to cooperate with the appropriately preconfigured module, the key generation occurring as part of the module registration process with the back end, itself enabled by the smart mobile device and/or online module, or as part of a communication between smart mobile device and module. Additionally, initial digital keys may be generated offline between the module and smart mobile device by triggering initial key exchange via the sharing of a secret, for example, through scanning a QR-code with the instructions to get access to the secret.

With respect to communication, symmetric key based communication makes use of a single shared key which is kept secret and used to encrypt and decrypt messages. Asymmetric key based communication uses a public key/private key combination wherein the public key may be freely and openly made available and used to decrypt data encrypted with the private key which is kept in secret. Here, a sender encrypts a message with the receiver's public key; only the holder of the private key, in this case the receiver, can decrypt this message. Attestation of the public key may be obtained from the certification authority during the decrypting step in order to ensure that the public key validly belongs to the claimed owner. To this end, embodiments of the present invention employ Public Key Infrastructure (PKI) best practices while offering a proprietary Certification Authority (CA).

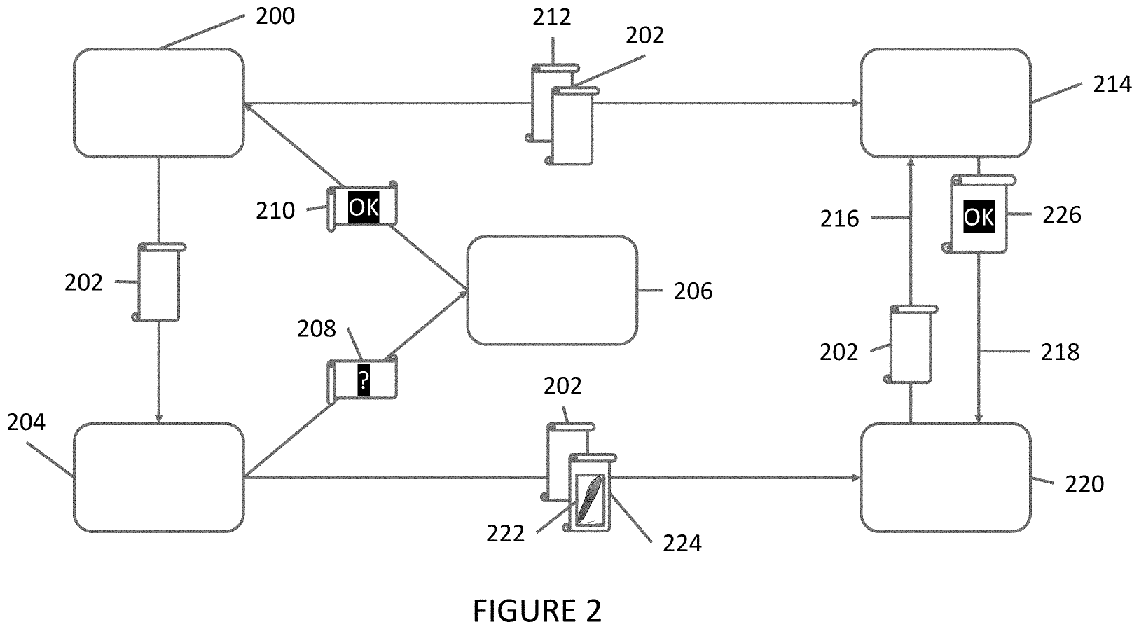

Throughout, message and data are used interchangeably with the understanding that the skilled person when applying the aforementioned would understand that both and/or either of the message and data may be encrypted with at least one of the symmetric and asymmetric keys. Embodiments of the present disclosure are further configured to support any one or more of the following: asynchronous crypto algorithms RSA, Diffie-Hellman, ECMQV, DSA, KCDSA, ECDSA, ECDH and Edwards (X25519, Ed25519ph); synchronous crypto algorithms AES, AES-GCM, ARIA, Camellia, CAST, RIPEMD160 HMAC, SEED and Triple DES; and hash algorithms SHA-1, SHA-2 (224, 256, 384, 512 bit) and HAS-160. Example digital certificates generation, communication and use in confirmation of communication establishment between smart mobile device and module is set out in FIG. 2.

As is known in the art, PKI is a set of roles, policies, hardware, software and procedures needed to create, manage, distribute, use, store and revoke digital certificates as well as manage public-key encryption. Its purpose is to facilitate secure electronic transfer of information through the binding and authenticating of public keys to and with respective communicating entities. Example public key infrastructure and process flow of the implementation of the same is depicted in FIG. 2. As shown, certification authority (CA) 200 is configured to register and issue digital certificates 202 for requesting users 204. Here, the CA has delegated public key vetting and validating to a registration authority (RA) 206, including: identification and authentication of certificate applicants, approval or rejection of certificate applications, initiating certificate revocations or suspensions under certain circumstances, processing subscriber requests to revoke or suspend their certificates, and approving or rejecting requests by subscribers to renew or re-key their certificates. Alternatively, RAs may be dispensed with, as in the case of standalone CAs, or offered as stand-alone components. As depicted, user 204 requests 208 a digital certificate from the RA 206 which, upon authentication of the user 204, issues an approval 210 to the CA 200 which in turn generates and sends the certificate 202 to the user 204. Likewise, the CA keeps a validation authority (VA) 214 informed of current and valid registrations 202, 212 for the VA to subsequently use in validating 218 attestation requests 216 from an entity 220. The entity, as will be detailed hereafter, may include the instant module, electronic lock, and the like. In addition to a list of valid certificates, the VA may host a list of revoked certificates which, in effect, returns an invalid attestation thereby causing the entity to doubt the authenticity of the underlying request. Further still, such list may be stored in an appropriately configured module and uploaded thereto as part of maintenance information either directly when the module is an online module or via smart mobile devices associated with the module during the normal usage interaction with module by the user or via specific maintenance function in any smart mobile device.

As depicted in FIG. 2, the user 204 communicates a digitally signed 222 command 224 and public key 202 to entity 220 which in turn requests 216 the VA 214 to validate the public key 202. For offline modules, such requests would be processed internally. As depicted, VA 214 validates 226 the certificate and communicates 218 the validation back to the entity which now understands with a greater degree of certainty that the communication 224 originated with the user 204. Likewise, should the public key be revoked, the VA would return a negative attestation thereby resulting in the entity doubting the communication. As shown in FIG. 2, the communication 224 may now be safely processed by entity 220 because there is certainty that the communication originated with the user 204. Assuming that the sender signed 222 the communication 224 with its private key, the entity 220, now in possession of the attested public key 202 may use it to decrypt the communication to arrive at the content thereof.

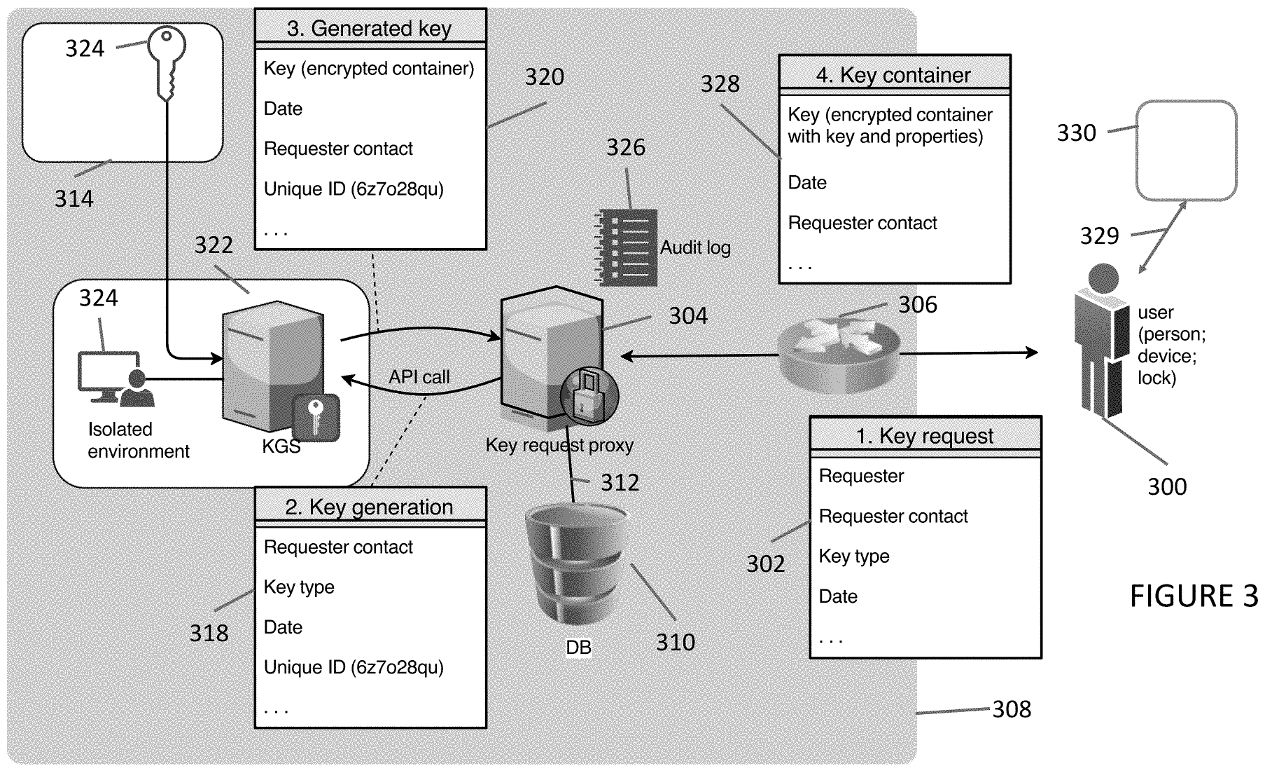

FIG. 3 depicts key generation architecture according to embodiments of the present disclosure. As shown, a key request 302 from a user 300 in the frontend comes into the key request proxy 304 via a router 306 arranged in the backend between the user 300 and the key request proxy. The router 306 may comprise a network router and further include a firewall as well as be configured to be a network device and/or gateway into network 308. The key request proxy 304 includes direct access 312 to a database 310. The database 310 may be configured for use with audits and may hold information about who has permission to get what keys to which environment. For example, if there is a permission record in the database, then a key may be generated according to those permissions. In addition to the keys that are used to communicate commands, e.g. lock/unlock, the key generation service may also generate keys for encrypting communication channels, software inside the modules, as well as software and its components residing on the smart mobile devices. Still further uses may include automatically triggering payment and/or other forms of compensation automatically, namely, without additional input or other such action by the digital key user. Audit logs may be separate services (326) configured to track and log every event that happens in the system. The proxy 304, via an API call, requests a key to be generated 318 by the key generating server 322 which may operate in an isolated environment 324, such as in a separate Virtual Private Data Center (VPDC) with controlled access thereto for enhanced security purposes. The requested key is then generated by the key generating server and extracted from vault 314. The vault may include a master key 324 which may be used to sign the digital key generator to generate the keys as well as with different generators for different levels of security based upon different encryption algorithms. The master key 324 may be physically stored in a safe, in a USB, or other physical medium. The generated key may be communicated back 320 to the proxy 304, where it is logged 326, packaged 328, and communicated back to the user 300 via router 306 for subsequent communication and use (329) with a module 330.

All requests and activities may be saved in a data warehouse which is encrypted and which may be accessed only by key generators and policy servers. Log analyzers may be employed, with the analyzers having read-only access to data, while the data may be anonymized and coded via indexes of locks and users. The keys generated are unique for every user and their respective smart mobile device. Accordingly, the same key cannot be transferred for use in or on another smart mobile device, even if such belongs to the same user. Alternatively, special permissions may be included in the key generation for selective sharing and the like. Keys may be revoked in the backend (e.g. revocation of their digital certificate) rendering the key unusable. Appropriate measures are in place to communicate such revoked or blacklisted keys to online as well as offline locks or modules. Such may include affecting such communication directly or via the proprietary application running on the user's mobile device. The number of keys generated becomes limited only by the capacity of the mobile device to accommodate them.

Modules, according to embodiments of the present description, may be maintained with provision of maintenance information. Such provision may be regular, periodic or ad hoc. While online modules may receive maintenance information, such as timing, clock, firmware updates, blacklisted keys, and the like, from the backend by virtue of their respective online connections, offline modules receive such information via maintenance channels set up between smart mobile devices, as may be affected by the aforementioned as well as proprietary applications running thereon, and the offline modules. Online modules may also receive maintenance information accordingly.

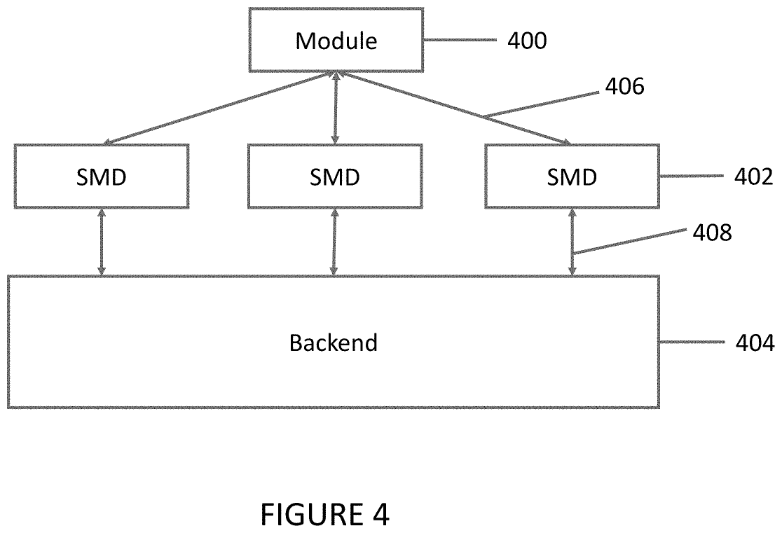

FIG. 4 depicts maintenance channels with an offline module 400 which may be affected by dispensing the maintenance information to one or more smart mobile devices 402 registered for use with the particular offline module 400. Such information would be known from the maintained database log within, for example, the backend 404. The smart mobile device(s) 402 would then impart the maintenance information to the offline module when next in communication 406 therewith. For example, a communication 408 may be made between the backend 404 and the smart mobile devices 402 that a particular key is now blacklisted. If or when any of the smart mobile devices 402 come again into contact and/or communication 406 with the module 400 thereafter, as part of the normal locking/unlocking communications detailed above, the smart mobile device 402 would automatically deliver an update to the offline module 400 list of blacklisted keys via the communication 404. The offline module 400 in turn would then update its list accordingly. Maintenance information may be communicated from a single smart mobile device 402 to the offline module 400 or via a series of smart mobile devices, each delivering a portion of the overall maintenance information. The offline module 400 may in turn be configured to receive information, whole or piecemeal, reassemble such information as may be needed, and update its store of information with the new information accordingly. Further still, once the maintenance information has been communicated, the offline module 400 may communicate (406, 402, 408) back to the backend 404, a confirmation of the update and/or simply instruct the smart mobile device to delete the maintenance information currently therein. The proprietary software application described above and currently running on the smart mobile device 402 in this example facilitates the aforementioned communication without engagement or input required from the user. Alternatively, the user may be afforded the opportunity to consent to such maintenance information sharing. Both the maintenance information and the channel of communication via which it is communicated to the module may be encrypted. The aforementioned may also be applied to online modules.

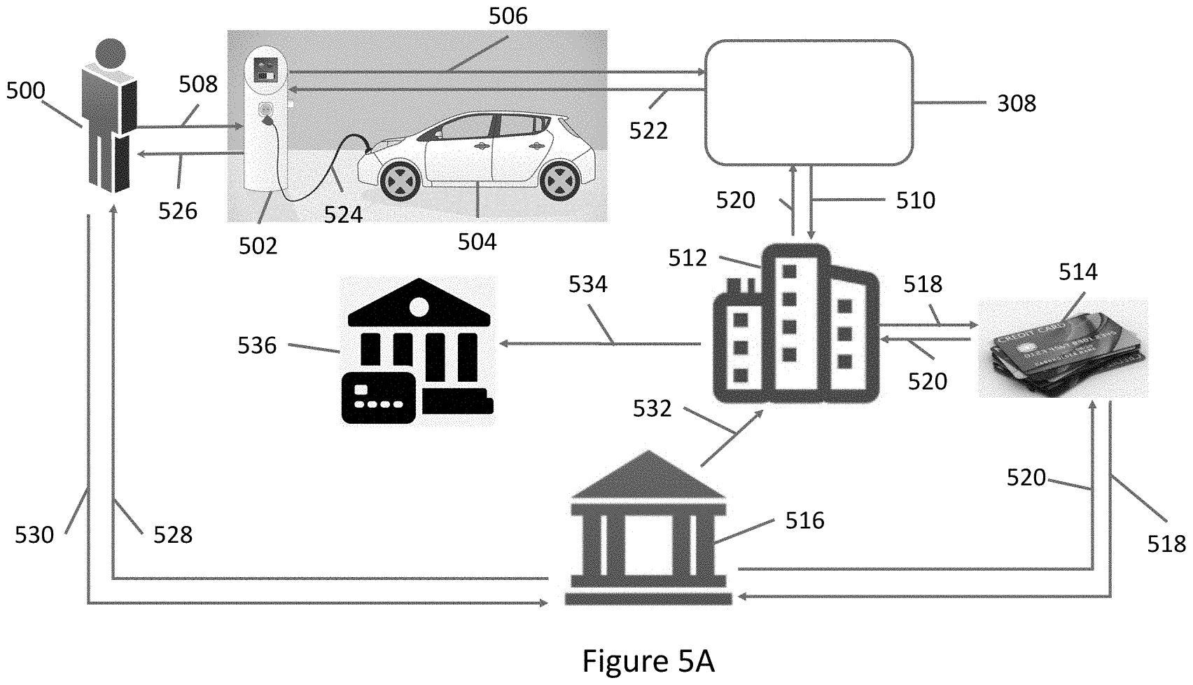

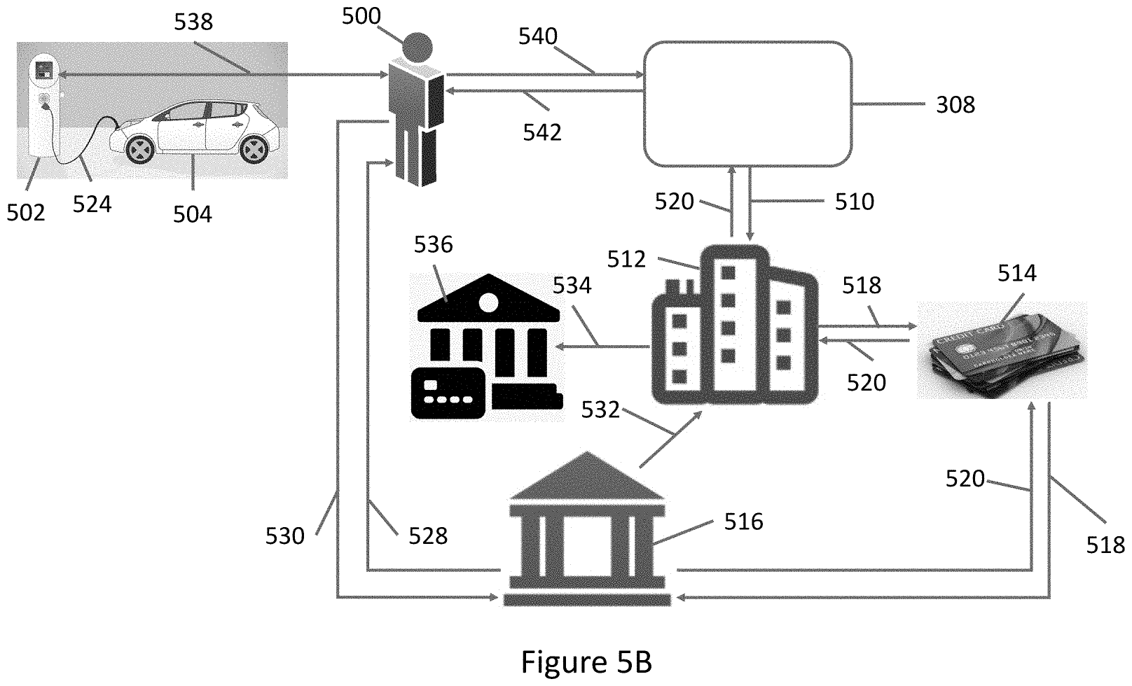

An example application of the present disclosure is set out in FIGS. 5A and 5B which depict a user engaging a module for unlocking power to charge an electric vehicle. As depicted, a user 500 initiates communication 508 with a module charging station 502. The communication, along with all subsequent communications detailed hereinbelow, may be established along lines set out above, may be wireless, via a keypad, card reader and the like, and may further be encrypted. Via such communication, user 500 sends a command instructing charging station 502 to release power to charge (524) electric vehicle 504. Concurrent with the command is user payment information for enabling delivery of power to the vehicle, the user payment information optionally provided with an additional consent requirement to the user, automatically with the communication of the commands and/or the like. The user payment information along with any required triggers for execution of same may be included within the digital key. The payment information may refer to an account, debit card, credit card and the like of the transaction pre-paid or post paid variety. For illustrative purposes, authentication of credit card payment is depicted in FIGS. 5A and 5B, with the following being adaptable to other forms of payment processing as would be understood by the skilled person. Appropriate accounting software, e-commerce software, invoicing software, CRM tools, and/or the like along with appropriate resources for supporting the same, are made available throughout to execute the following. By way of example, such resources are located in network 308 (see FIG. 3) which may be further configured to act as a payment gateway, while locating such resources elsewhere within the following may be made, such as at the module, the user's smart mobile device and/or the like, so long as user credit card information and the like is effectively contained within the digital key and made available for automatic processing, namely, without further intervention from the user but for the initiation of the intial overall request to the module, which, as is the case here, the release power for charging a vehicle. Returning to FIG. 5A, with the user wishing to make payment for the unlocking of charging power and the present embodiment enabling such payment along with subsequent provision of service based upon approval and denial of the same, module 502 communicates 506 with network 308 user credit card information, which may include any one or more credit card number, user ID, PIN and/or other information as may be required for the processing. The network 308, here acting as the payment gateway, sends (510) the secured user data to the credit card processing company 512 for approval/denial of payment. During this process, the credit card processing company 512 makes use (518) of the credit card network 514 to communicate further (518) to the card issuing bank 516 which either approves or rejects the transaction (e.g., releasing a select amount of funds to compensate for the release of charge to the vehicle) based upon the user's funds with the card issuing bank. The approval or rejection is then communicated 520 back through the credit card network 514 to the credit card processing company 512 and payment gateway/network 308 which then further communicates 522 the approval or denial directly to module 502. Upon receipt of the approval, module 502 automatically unlocks electricity and makes it available for charging 524 the electric vehicle 504. Upon receipt of the denial, no electricity is released. In either of the aforementioned, the user 500 is updated 526 regarding the status of its request to charge its vehicle 504, including the status of the payment processing request. Assuming approval, the card issuing bank 516 then charges the payment to the user's account and transfers 532 the same via processing company 512 to (534) the bank account 536 associated with module 502. Depending upon the arrangement between the user and its bank, the carding issuing bank 516 may further charge the user 500 directly (528) for payment 530 of the amount requested for processing. The aforementioned typically takes a matter of seconds depending upon infrastructure resources relied upon by the aforementioned.

FIG. 5B depicts the user in a “man in the middle arrangement” between an offline module 502 and payment gateway/network 308. By way of example, the module may be configured to compare user id from user 500 with a previously stored list of approved users, the list including particular resources (e.g. power levels, duractions and the like) associated therewith, as a means for approving payment for charging vehicle 504. The list may be maintained through maintenance data delivered to module 502 via procedures described above.

Where the module is not configured to confirm a payment request process and/or by selection of the user, credit card payment requests may be processed using the network 308 as a payment gateway. Here, as with FIG. 5A, namely, a request is submitted (510) to the processing company 512 which in turn requests 518 approval or denial of same from card issuing bank 516 via the credit card network 514. If approved, the user 500 may be charged (528) for payment (530) accordingly. Upon communication 520 of the approval or denial back to the payment gateway/network 308, the user is informed 542 via its smart mobile device. The approval or denial is then communicated 538 to module 502, instigated either manually or automatically, in order to facilitate the user's desired access to the charging power, namely, unlocking the module. As such, modules would not require permanent or temporary online status, thereby widening application of the present invention to a variety of heretofore unavailable applications as well as ease the burden on module providers regarding where and how their modules may be configured and arranged.

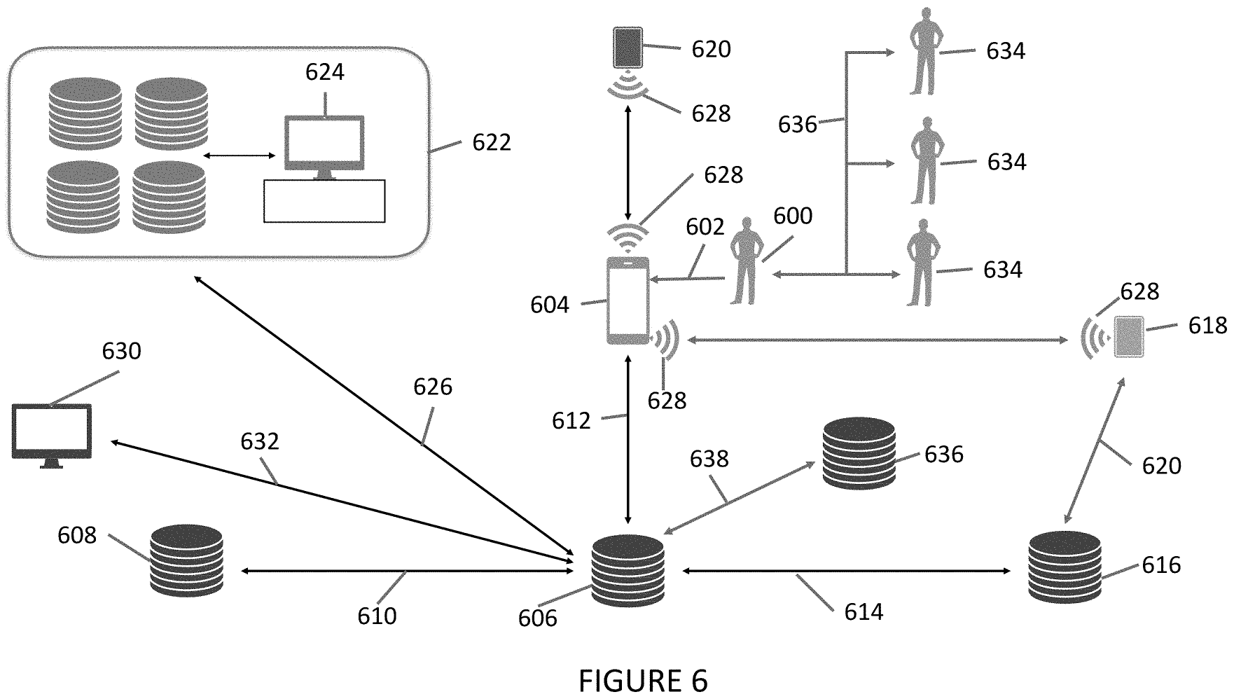

FIG. 6 depicts a process flow overview for obtaining a digital key and making use of same in accordance with embodiments of the present disclosure. Although a disruptive flow management scheme is depicted, other schemes may be employed as envisioned by the skilled person. As shown, user 600 obtains and otherwise loads 602 a proprietary software application to its smart mobile device 604. The application is installed and run on smart mobile device 604. As part of the installation process, the user completes and sends off a registration 612 to the backend. The registration is directed, via an API, to a first application 606 configured for saving and obtaining a digital key personal to the user, as well as manage user identification, permissions and devices. Such application may be running on a server and include API gateway and routing functionality.

When registered, the user may become a module owner and will receive an appropriate digital key to use the module. Alternatively, the user may receive the key from another module owner (634, 636). If the user is the module owner, the user will use their smart mobile device to identify the module intended for tie into the user's account. The identification may be effected by scanning a QR code and the like present on the module or via other similar such identification means. Such identification may find application with offline module 620 or online module 618. Once identified, the module is also registered in the first application 606. Registrations may be stored in a database as set out hereinabove.

The first application 606 proceeds to obtain 610 from a second application 608, via an API, the generation of the digital key for the user along with any related and/or proprietary applications and modules as communicated within the user's registration. The generated digital key may be then related to the registered module and generated by the example arrangement set out above. The second application 610 may also be running on a server and include appropriately configured functionality to generate digital keys in accordance with embodiments of the present disclosure. The first application 606 further requests 614, via an API, device data and, optionally, module opening or unlocking via LAN, etc. with digital keys from a third application 616 running on a server and appropriately configured to be tasked with online device 618 monitoring 620 procurement and maintenance information updates. The module opening may be obtained for online modules responsive to online commands instigated by at least the third application 616 or for offline modules (620) as may be instigated as part of the registration process or subsequently thereafter in order to facilitate ease of use. An administration tool 630 to at least monitor logs and manage users, devices and permissions may be appropriately configured and arranged in communication 632 with the first application 606. The first application 606 may exchange user and key information, though not necessarily the digital key itself, with third party solutions 622 which, as connected via an API 626, may also grant access, generate keys and revoke keys as depending upon particular solution and administration 624 thereof. The digital keys may now be sent back (612) to the smart mobile device 604 for use in communication with a module. Two modules which may include electronic locks are depicted: an offline lock 620 arranged in communication 628 with mobile device 604 and an online lock 618 also in communication 628 with mobile device 604 but also in networked communication with the aforementioned applications and the like. The communications 628 may be proximity based and comprise any communication scheme and standard envisioned by the skilled person.

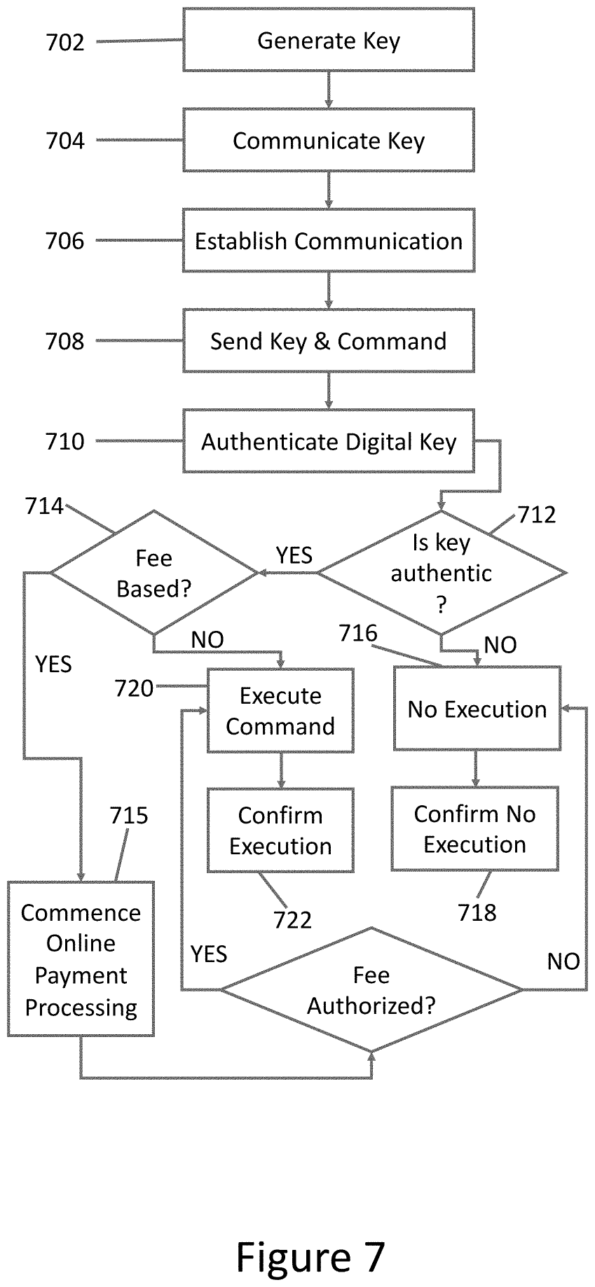

A method for communicating between a smart mobile device and a module is set out in FIG. 7. By way of an initial step 702, a digital key is generated on behalf of a registered user and then communicated to the user (step 704), the aforementioned may be as detailed above. By way of alternative, the smart mobile device may be preconfigured with one or more digital keys, such preconfiguration activated as part of the registration process or another process in order to bring the one or more or other digital keys into an active use mode. Communications may be affected with one digital key or a plurality of digital keys. The smart mobile device is brought sufficiently proximate to the module (step 706) so as to enable an electronic communication therebetween. The electronic communication may be of any communication standard(s) known to the skilled person suitable for the respective smart mobile device and module, themselves suitably configured and enabled for such communication standard(s). The communication between smart mobile device and module may be selectively encrypted. With the registration of the module to the user, the type of key to be used in authenticating the user, via the proprietary software, becomes known in advance to at least the proprietary software running on the smart mobile device. Payment authentication may further be automatically initiated by certain content of the digital key, the authentication facilitated via third party solutions as well as local to the module implementation. Accordingly, once proximate to the module, the smart mobile device may automatically (by virtue of the proprietary software running thereon) or via manual prompting (by virtual of manual activation of an appropriate feature of the proprietary software running thereon), communicate the digital key and optionally the command(s) to the module (step 708) via the aforementioned electronic communication. The command(s) may alternatively be communicated at other times during this method. Certain limitations of geography and/or time may be included here to facilitate or deny command(s) communication(s). With receipt of the digital key, the module in turn authenticates the key (step 710). For offline modules, such authentication may occur entirely locally, with local processing components receiving, identifying and verifying the received digital key as for example against a list of authentic digital keys maintained on the offline module by virtue of communicated maintenance information. For online modules, such authentication may occur locally or remotely by design, such as for example detailed above with respect to the attestation of public keys. By way of an alternative, offline modules may affect public key attestation via a smart mobile device, in communication therewith, acting in a “man in the middle” capacity. Returning to FIG. 7, a determination (step 712) is then made whether the received digital key is authentic (YES) and if so a next determination is made whether the unlocking requested by the user is fee based (714). Where the unlocking is fee based (YES), such as the aforementioned releasing of electricity to charge an electric vehicle, payment processing (715) is commenced, for example by of payment processing set out hereinabove. As part of the payment processing, a determination 717 is made whether the fee is authorized. If so (YES), the user requested and communicated command is executed (720) and confirmed with the user (722). If the fee was not authorized (NO), the command is not executed (716) and the user informed accordingly (718). Returning to 714 and whether the command is fee based, in the event it is not (NO), then the user command is executed 720 and confirmed with the user 722 since the key (and the user by association) has already been determined as being authentic (712, YES). If the key was found not to be authentic (712, NO), the user requested command would not be executed (716) and the user informed accordingly (718). While the aforementioned method has been described by way of unlocking electricity for charging an electric vehicle, the same may be applied to the unlocking of a secured location, providing access to virtual resources and other applications as mentioned throughout.

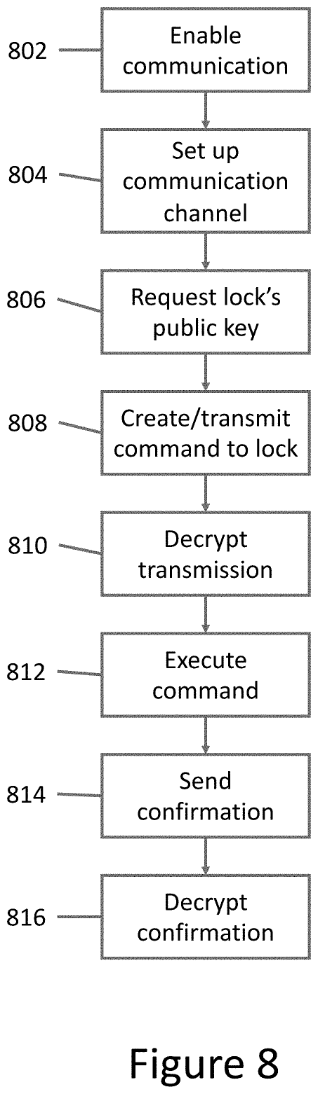

Another method according to an embodiment of the present disclosure is set out in FIG. 8. The method begins at a first step 802 wherein communication is established between the smart mobile device and electronic lock. Such communication may be established by the physically bringing of the smart mobile device into sufficient proximity with the electronic lock so as to enable an initial exchange and/or communication therebetween using known standards and procedures for such communication. With communication enabled, an encrypted communication channel may be set up (step 804) between smart mobile device and module. The heretofore downloaded proprietary application may enable the setting up of the encrypted communication channel, such operationally being further facilitated by the module also being proprietary and appropriately pre-configured, as well as through data exchanged during the initial contact between the smart mobile device and module. Once established, a request is made to the module from the mobile device for the lock's public key (step 806). Once armed with the public key, the mobile creates a command, such as “unlock” and/or “open” or other specific command as an instruction for the module depending upon application thereof. For example, when applied in an elevator or other moving vehicle, such command may include a destination and when applied to the provision of charging power, such command may include duration and level. Related application into, for example, the Shared Economy may be affected as envisioned by the skilled person. The smart mobile device signs the command using the private key and transmits the signed command, along with its public key, to the module, the transmission being optionally further encrypted with the module's public key (step 808). At the module, its pre-programmed (or newly provided as may be the case for at least online modules) private key, associated with the communicated public key, is used to decrypt the transmission which was previously encoded, by the smart mobile device, optionally running the proprietary software and/or using other appropriate software, with the module's public key. At the module, the public key received in the transmission is attested (as per its digital certificate) and if found valid, used to decrypt the transmission (step 810). If the transmission is not attested, a number of retrys would be attempted followed by an error message to the smart mobile device if such attempts also prove unsuccessful (not shown). The command in the transmission is then executed (step 812) and a confirmation of the same is generated, encrypted with the lock's private key and transmitted back, along the encrypted channel, to the mobile (step 814) which then uses the lock's public key, already in its possession, to decrypt the confirmation (step 816). To the extent the aforementioned has been set out with respect to an offline module, it may also apply to online modules, wherein the appropriate processing capabilities normally resident on the offline module may be alternatively located remotely and online. Additionally, functionality, such as automatically opening the online electronic module during the registration process may be executed. Likewise, the module may broadcast its public key and the mobile device and lock may simply communicate using public/private key messages absent the encrypted channel.

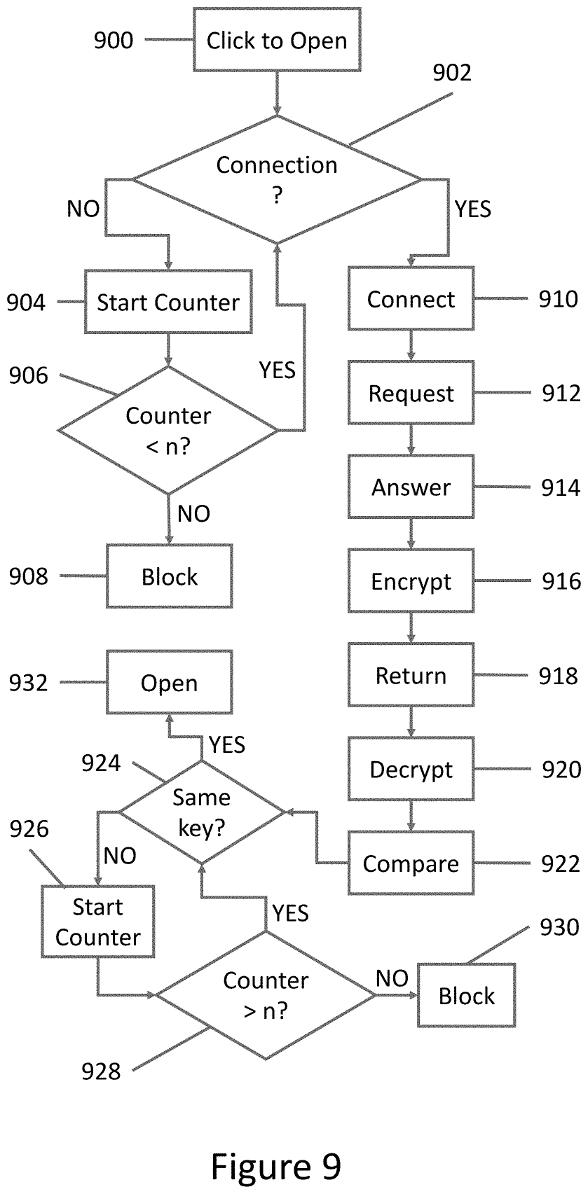

Another method according to another embodiment of the present disclosure is set out in FIG. 9. Application of this another method may be with respect to an electronic lock for a gate, the electronic lock optionally being arranged within a suitable module. Prior to the start of the method as depicted, the user has downloaded and is otherwise running the proprietary software on a smart mobile device. The smart mobile device is either brought proximate to the module and automatically requests the gate to be opened or is manually activated by the user (step 900). The proprietary software application scans for nearby modules which are enabled for communication with the smart mobile device. Such communication may be targeted with advance knowledge known to the proprietary software by virtue of pre-programming along with location information available from the smart mobile device. Here, the communication may be for example a search for a Bluetooth enabled module having a particular Bluetooth name such as EHG0AA01. When found, a connection with the module from the smart mobile device is attempted (step 902). If the connection set up fails (NO), a counter within the proprietary software may start (step 904), run for n number of retries (906) which if it still fails (NO) will block future connection attempts. If a retry is successful (YES) or if the initial try is successful, the method continues in establishing a connection (step 910) and when the proprietary software has a connection to the module, the proprietary software sends a request (step 912) to the module which is then answered (step 914) with a randomized string, such as 1257282715093802. The proprietary software may then (step 916) use an AES algorithm to encrypt the randomized string with a users' key which may be stored in a database and/or on the module so as to optionally only be known to the proprietary software and the module. Accordingly, the users' key would not be known to the user. The key may optionally not be transmitted over the air. Returning to the method, the encryption may appear as follows:
1257282715093802 [symbol] 3144969151781450
g0czibdmahfh5m793ptvtm871oqb6qkq
The above result is communicated back (step 918) to the module which then decrypts the result (step 920) with the known user key. Such may appear as follows:
g0czibdmahfh5m793ptvtm871oqb6qkq [symbol] 3144969151781450
=
1257282715093802
   The module then compares the aforementioned second result with the aforementioned randomized string (step 922). Where there is a match (YES), the module would know that the aforementioned was encrypted with the same user key and the module triggers the command, such as opening the gate (932). Where there is not a match (NO), a counter is started (step 926) for execution of a number of retries (928) of step 724 which, if any are successful (YES) result in the command being executed (step 932, gate open). If the number of retries is exceeded without success (NO), the command is blocked (930). Alternatively, the number of retries may be time based. The module may have one master key, while the user may have at least 99 unique user keys. While the aforementioned has been described with respect to unlocking access to a location, such may be applied to the unlocking of access to commodities, goods and/or services.

While application of embodiments of the present disclosure are set out above with respect to the modules being online and offline locks, other embodiments may be envisioned. For example, an embodiment of the present disclosure may be applied to the controlled access to software. Such access may pertain to the initial installation on a suitable device, access to software already running on a device and the like.

Further embodiments may include application to elevators and other such transportation means wherein a particular interaction is required to enable the transportation, the interaction including certain authentications and/or commands from the transportee. Such applications may include certain security features such as time based command entry. For example, a user running the proprietary software on its smart mobile device may have a certain time span, such as 10 seconds, in which to enter a desired floor, once the smart mobile device authenticated itself with the elevator. Other transportation may include private, commercial and public motor vehicles.

The modules described herein may be applied to at least one of a door lock module, a garage door module, a car gate module, a software access module, a elevator control module, a vehicle control module, a parcel delivery cabinet and a locker control module. Here, the module affects entry, egress, access and the like, as per the particular application, in a manner as described herein.

Communication in the present embodiments may be affected by communication modules comprising network and communication chips, namely, semiconductor integrated circuits that use a variety of technologies and support different types of serial and wireless technologies as envisioned by the skilled person. Example serial technologies supported by the communication module include RS232, RS422, RS485, serial peripheral interface, universal serial bus, and USB on-the-go, Ethernet via RJ-45 connectors or USB 2.0. Example wireless technologies include code division multiple access, wide band code division multiple access, wireless fidelity or IEEE 802.11, worldwide interoperability for microwave access or IEEE 802.16, wireless mesh, and ZigBee or IEEE 802.15.4. Bluetooth® or NFC chips may be used to provide wireless connectivity in solution-on-chip platforms that power short-range radio communication applications. The communication module may be configured to operate using 3G, 4G or 5G technology standards, including: universal mobile telecommunications systems, enhanced data rates for global evolution and global system for global communication. The 4G standard is based solely on packet switching, whereas 3G is based on a combination of circuit and packet switching.

Processing in the present embodiments may be affected by processors disposed in communication with one or more memory devices, such as a RAM or a ROM, via a storage interface. The storage interface may connect to memory devices including, without limitation, memory drives, removable disc drives, etc., employing connection protocols such as serial advanced technology attachment, integrated drive electronics, IEEE-1394, universal serial bus, fiber channel, small computer systems interface, etc. The memory drives may further include a drum, magnetic disc drive, magneto-optical drive, optical drive, redundant array of independent discs, solid-state memory devices, solid-state drives, etc.

Memory devices may be used to store a collection of program or database components, including, without limitation, an operating system, a user interface application, a user/application data (e.g., any data variables or data records discussed in this disclosure), etc. The operating system may facilitate resource management and operation of the computer system. Examples of the operating system include, without limitation, Apple Macintosh OS X, Unix, Unix-like system distributions, Linux distributions, IBM OS/2, Microsoft Windows, Apple iOS, Google Android, Blackberry OS, or the like. The user interface may facilitate display, execution, interaction, manipulation, or operation of program components through textual or graphical facilities, including but not limited to touch screens. For example, user interfaces may provide computer interaction interface elements on a display system operatively connected to the computer system, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

It will be appreciated that, for clarity purposes, the above description has described embodiments of the technology described herein with reference to different functional units and processors. However, it will be apparent that any suitable distribution of functionality between different functional units, processors or domains may be used without detracting from the technology described herein. For example, functionality illustrated to be performed by separate processors or controllers may be performed by the same processor or controller. Such may be located on individual servers, co-located and the like as envisioned by the skilled person. Hence, references to specific functional units are only to be seen as references to suitable means for providing the described functionality, rather than indicative of a strict logical or physical structure or organization.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

1. A system for controlling access permission to at least one of a module-controlled location and module-controlled service, the system comprising:
a backend configured to generate at least one digital key based upon a selected one of a plurality of escalating encryption security level encryption standards;
a frontend arranged in communication with the backend, the frontend configured to establish an encrypted communication with the module and communicate the digital key and a module executable command to the module via the encrypted communication;
wherein the encryption standards comprise at least one key generator service based upon at least one of Payment Card Industry Data Security Standards and certified HSM; and
wherein the digital key is configured to enable the access permission.

2. The system according to claim 1, wherein:
the digital key is configured to trigger a payment verification process; and
the access permission is triggered by approval received from the payment verification process.

3. The system according to claim 2, wherein the front end is configured to communicate at least one of an approval of access and a denial of access, the approval of access and the denial of access arising out of the payment verification process.

4. The system according to claim 3, wherein:
the module is configured to perform in response to the approval of access; and
the module is configured to not perform in response to the denial of access.

5. The system according to claim 4, wherein the module comprises at least one of:
a charging station configured to release charging power in response to execution of the the module executable command;
an electric lock configured to enable egress and ingress to at least one of a location and a service, in response to execution of the mobile executable command; and
a virtual lock configured to enable access to virtual resources.

6. The system according to claim 1, wherein at least one of the frontend and the backend is further configured to count a number of times an executable command has been communicated and prevent subsequent communication of the executable command after the count has exceed a threshold.

7. The system according to claim 1, wherein the module is configured to authenticate the digital key and to execute the command if the digital key is authentic.

8. The system according to claim 7, wherein the front end further comprises a smart mobile device configured to affect at least one of the encrypted communication and generation of digital keys.

9. The system according to claim 8, wherein the digital key is configured to be at least one of unique and assignable to a single user.

10. The system according to claim 9, wherein the backend is configured to authenticate digital keys and communicate digital key authentication to the module.

11. The system according to claim 10, wherein the digital key is asymmetric, and the backend comprises a certification authority for attesting public keys.

12. The system according to claim 11, wherein communication within the backend is encrypted and the at least one digital key is generated in a virtual private data center with controlled access within the backend.

13. The system according to claim 12, wherein:
the backend is configured to generate a list of blacklisted digital keys and communicate the list to the module; and
the module is configured to query the list during digital key authentication.

14. The system according to claim 13, wherein the backend is configured to generate module maintenance information and communicate the module maintenance information at least one of directly to the module and indirectly to the module via at least one smart mobile device.

15. A method for controlling access to a module-controlled location, the method comprising the steps of:
generating in a backend at least one digital key based upon one of a plurality of escalating encryption security level encryption standards, the digital key comprising at least one module executable command and a payment verification trigger;
communicating the at least one digital key to a smart mobile device;
establishing an encrypted communication channel between the smart mobile device and the module;
communicating the at least one digital key to the module via the encrypted communication channel;
authenticating the at least one digital key at the module;
executing the module executable command at the module if the at least one digital key is authentic and not executing the module executable command if the at least one digital key is not authentic; and
wherein the encryption standards comprise at least one key generator service based upon at least one of Payment Card Industry Data Security Standards and certified HSM.

16. The method according to claim 15, wherein:
the module is configured to authenticate the digital key and to execute the module executable command if the digital key is authentic; and
the front end is configured to communicate at least one of an approval and denial arising out of a payment verification process.

17. The method according to claim 16, wherein the module is configured to:
perform the payment verification process; and
ignore the mobile executable command after receipt of the denial.

18. The method according to claim 17, wherein at least one of the frontend and the backend is further configured to count a number of time the mobile executable command has been communicated and prevent subsequent communication of the mobile executable command after the count has exceed a threshold.

19. The method according to claim 18, wherein the module comprises at least one of:
a charging station configured to release charging power in response to execution of the module executable command by the module;
an electric lock configured to enable egress and ingress to at least one of a location and a service; and
a virtual lock configured to enable access to virtual resources.

20. The method according to claim 19, wherein:
the backend is configured to generate a list of blacklisted digital keys and communicate the list to the module and the module is configured to query the list during digital key authentication; and
the backend is configured to generate module maintenance information and communicate the module maintenance information directly to module and indirect to the module via at least one smart mobile device.
